(19) United States
(12) Patent Application Publication
(10) Pub. No.: US 2022/0123352 A1
(43) Pub. Date: Apr. 21, 2022

(54) SOLID-STATE BIPOLAR BATTERY INCLUDING IONOGEL

(71) Applicant: GM GLOBAL TECHNOLOGY OPERATIONS LLC, Detroit, MI (US)

(72) Inventors: Zhe LI, Shanghai (CN); Yong LU, Shanghai (CN); Qili SU, Shanghai (CN); Meiyuan WU, Shanghai (CN); Haijing LIU, Shanghai (CN)

(73) Assignee: GM GLOBAL TECHNOLOGY OPERATIONS LLC, Detroit, MI (US)

(21) Appl. No.: 17/481,179

(22) Filed: Sep. 21, 2021

(30) Foreign Application Priority Data
Oct. 16, 2020 (CN) 2020111094493

(51) Int. Cl. H01M 10/056; H01M 10/0525; H01M 4/62; H01M 4/66

(52) U.S. Cl. CPC H01M 10/056; H01M 10/0525; H01M 2004/029; H01M 4/667; H01M 4/628

(57) ABSTRACT

A high-temperature stable solid-state bipolar battery is provided. The battery includes two or more electrodes, one or more solid-state electrolyte layers, and an ionogel disposed within void spaces within the battery. Each electrode includes a plurality of solid-state electroactive particles. Each solid-state electrolyte layer includes a plurality of solid-state electrolyte particles and a first solid-state electrolyte layer of the one or more solid-state electrolyte layers may be disposed between a first electrode and a second electrode of the two or more electrodes. The ionogel is disposed within void spaces between the two or more electrodes, the solid-state electroactive particles of the two or more electrodes, the solid-state electrolyte particles of the one or more solid-state electrolyte layers, and the one or more solid-state electrolyte layers, such that the battery has an reduced interparticle porosity. The ionogel may have an ionic conductivity between about 0.1 mS/Cm and about 10 mS/cm.

### CROSS-REFERENCE TO RELATED APPLICATIONS

This application claims the benefit and priority of Chinese Application No. 2020111094493, filed Oct. 16, 2020. The entire disclosure of the above application is incorporated herein by reference.

### INTRODUCTION

This section provides background information related to the present disclosure which is not necessarily prior art.

Electrochemical energy storage devices, such as lithium-ion batteries, can be used in a variety of products, including automotive products such as start-stop systems (e.g., 12V start-stop systems), battery-assisted systems (“μBAS”), Hybrid Electric Vehicles (“HEVs”), and Electric Vehicles (“EVs”). Typical lithium-ion batteries include two electrodes and an electrolyte component and/or separator. One of the two electrodes can serve as a positive electrode or cathode, and the other electrode can serve as a negative electrode or anode. Lithium-ion batteries may also include various terminal and packaging materials. Rechargeable lithium-ion batteries operate by reversibly passing lithium ions back and forth between the negative electrode and the positive electrode. For example, lithium ions may move from the positive electrode to the negative electrode during charging of the battery and in the opposite direction when discharging the battery. A separator and/or electrolyte may be disposed between the negative and positive electrodes. The electrolyte is suitable for conducting lithium ions between the electrodes and, like the two electrodes, may be in a solid form, a liquid form, or a solid-liquid hybrid form. In the instances of solid-state batteries, which include solid-state electrolyte layers disposed between solid-state electrodes, the solid-state electrolyte layer physically separates the solid-state electrodes so that a distinct separator is not required.

Solid-state batteries have advantages over batteries that include a separator and a liquid electrolyte. These advantages can include a longer shelf life with lower self-discharge, simpler thermal management, a reduced need for packaging, and the ability to operate within a wider temperature window. For example, solid-state electrolytes are generally non-volatile and non-flammable, so as to allow cells to be cycled under harsher conditions without experiencing diminished potential or thermal runaway, which can potentially occur with the use of liquid electrolytes. However, solid-state batteries generally experience comparatively low power capabilities. For example, such low power capabilities may be a result of interfacial resistance within the solid-state electrodes and/or at the electrode, and solid-state electrolyte layer interfacial resistance caused by limited contact, or void spaces, between the solid-state active particles and/or the solid-state electrolyte particles. Accordingly, it would be desirable to develop high-performance solid-state battery materials and methods that improve the contact and/or interaction between the solid-state active particles and/or the solid-state electrolyte particles (e.g., the micro-interfaces), the contact and/or interaction between the solid-state electrodes and solid-state electrolyte layer (e.g., the macro-interfaces), and/or mitigates the effects of the void spaces within the solid-state battery.

### SUMMARY

This section provides a general summary of the disclosure, and is not a comprehensive disclosure of its full scope or all of its features.

The present disclosure relates to solid-state batteries, for example solid-state bipolar batteries, that include ionogel, which wets interfaces between solid-state electrolyte particles and/or solid-state active material particles so as to reduce interparticle porosity and improve ionic contact. The solid-state batteries, for example the bipolar solid-state batteries, may further include polymer blockers that are configured to make contact with one or more adjacent current collectors so as to mitigate potential ionic short-circuit. The present disclosure also relates to methods for introducing the ionogel and/or polymer blocker(s).

In various aspects, the present disclosure provides a solid-state battery including two or more electrodes, one or more solid-state electrolyte layers, and an ionogel disposed within void spaces. Each electrode may include a plurality of solid-state electroactive particles. Each solid-state electrolyte layer may include a plurality of solid-state electrolyte particles, where a first solid-state electrolyte layer of the one or more solid-state electrolyte layers is disposed between a first electrode and a second electrode of the two or more electrodes. The ionogel is disposed within void spaces between the two or more electrodes, the solid-state electroactive particles of the two or more electrodes, the solid-state electrolyte particles of the one or more solid-state electrolyte layers, and the one or more solid-state electrolyte layers, such that the solid-state battery has an interparticle porosity of less than or equal to about 20 vol. %. The ionogel may have an ionic conductivity greater than or equal to about 0.1 mS/Cm to less than or equal to about 10 mS/cm.

In one aspect, the ionogel may include greater than or equal to about 30 wt. % to less than or equal to about 95 wt. % of an ionic liquid and greater than or equal to about 2 wt. % to less than or equal to about 40 wt. % of a solid component.

In one aspect, the solid component may include at least one of an organic polymer, an inorganic oxide, a polymer/oxide hybrid, and a metal-organic framework (MOFs).

In one aspect, the organic polymer may be selected from the group consisting of: poly(ethylene oxide)s (PEO) (where 1,000≤n≤10,000,000), poly(vinylidene fluoride-co-hexafluoropropylene)s (PVDF=HFP) (where 1,000 5×5 10,000,000 and 1,000≤y≤10,000,000), poly(methyl methacrylate)s (PMMA) (where 1,000≤n≤10,000,000), carboxymethyl celluloses (CMC) (where 1,000≤n≤10,000,000), polyacrylonitriles (PAN) (where 1,000≤n≤10,000,000), polyvinylidene difluoride (PVDF) (where 1,000≤n≤10,000,000), one or more poly(vinyl alcohol)s (PVA) (where 1,000≤n≤10,000,000), one or more polyvinylpyrrolidone (PVP) (where 1,000≤n≤10,000,000), and combinations thereof; the inorganic oxide may be selected from the group consisting of: SiO₂, Al₂O₃, TiO₂, ZrO₂, and combinations thereof; the polymer/oxide hybrid may include one or more of the organic polymers and one or more of the inorganic oxides; and the one or more metal-organic frameworks (MOFs) may be selected from the group consisting of: MIL-101, UiO-67, ZIF-8, and combinations thereof.

In one aspect, the ionic liquid comprises a cation and an anion. The cation may be selected from the group consisting of: Li(triglyme)methylimidazolium ([Li(G3)]⁺), Li(tetraglyme) ([Li(G4)⁺], 1-ethyl-3 ([Emim]⁺), 1-propyl-3-methylimidazolium ([Pmim]⁺), 1-butyl-3-methylimidazolium ([Bmim]⁺), 1,2-dimethyl-3-butylimidazolium ([DMBim]), 1-Alkyl-3-methylimidazolium ([Cnmim]⁺), 1-allyl-3-methylimidazolium ([Amim]⁺), 1,3-diallylimidazolium ([Daim]⁺), 1-allyl-3-vinylimidazolium ([Avim]⁺); 1-vinyl-3-ethylimidazolium ([Veim]⁺), 1-cyanomethyl-3-methylimidazolium ([MCNim]⁺), 1,3-dicyanomethyl-imidazolium ([BCNim]⁺), 1-propyl-1-methylpiperidinium ([PP₁₃]⁺), 1-butyl-1-methylpiperidinium ([PP₁₄]⁺), 1-methyl-1-ethylpyrrolidinium ([Pyr₁₂]⁺), 1-propyl-1-methylpyrrolidinium ([Pyr₁₃]⁺), 1-butyl-1-methylpyrrolidinium ([Pyr₁₄]⁺), methyl-methylcarboxymethyl-pyrrolidinium([MMMPyr]⁺), tetramethylammonium ([N₁₁₁₁]⁺), tetraethylammonium ([N₂₂₂₂]⁺), tributylmethylammonium ([N₄₄₄₁]⁺), tiallyldimethylammonium ([DADMA]⁺); N—N-diethyl-N-methyl-N-(2-methoxyethyl)ammonium ([DEME]⁺), N,N-Diethyl-N-(2-methacryloylethyl)-N-methylammonium ([DEMM]⁺), trimethylisobutyl-phosphonium ([P₁₁₁ᵢ₄]⁺), triisobutylmethylphosphonium ([P_{1i444]}⁺), tributylmethylphosphonium ([P₁₄₄₄]), diethylmethylisobutyl-phosphonium ([P₁₂₂₄]⁺), trihexdecylphosphonium ([P₆₆₆₁₀]⁺), trihexyltetradecylphosphonium ([P₆₆₆₁₄]⁺), and combinations thereof. The anion may be selected from the group consisting of: hexafluoroarsenate, hexafluorophosphate, bis(fluorosulfonyl)imide (FSI), bis(trifluoromethanesulfonyl(imide) (TFSI), perchlorate, tetrafluoroborate, cyclo-difluoromethane-1,1-bis(sulfonyl)imide (DMSI), bis(perfluoroethanesulfonyl)imide (BETI), bis(oxalate)borate (BOB), difluoro(oxalato)borate (DFOB), bis(fluoromalonato)boarate (BFMB), and combinations thereof.

In one aspect, the ionic liquid may further include a low-boiling point solvent selected from the group consisting of: dimethyl carbonate, ethylene carbonate, ethyl acetate, acetonitrile, acetone, toluene, propylene carbonate, diethyl carbonate, 1,2,2-tetrafluoroethyl, 2,2,3,3-tetrafluoropropyl ether, and combinations thereof.

In one aspect, the ionogel may further include greater than 0 wt. % to less than about 40 wt. % of one or more lithium salts. Each lithium salt includes an anion selected from hexafluoroarsenate, hexafluorophosphate, bis(fluorosulfonyl)imide (FSI), perchlorate, tetrafluoroborate, cyclo-difluoromethane-1,1-bis(sulfonyl)imide (DMSI), bis(trifluoromethanesulfonyl)imide (TFSI), bis(perfluoroethanesulfonyl)imide (BETI), bis(oxalate)borate (BOB), difluoro(oxalato)borate (DFOB), and bis(fluoromalonato)borate (BFMB).

In one aspect, the solid-state electrolyte layer may include a first layer including a first plurality of solid-state electrolyte particles, and a second layer including a second plurality of solid-state electrolyte particles, where the first and second pluralities of solid-state electrolyte particles are the same or different and first and second pluralities of solid-state electrolyte particles define the plurality of solid-state electrolyte particles.

In one aspect, the solid-state battery may further include two or more current collectors, where a first current collector of the two or more current collectors is disposed adjacent to the first electrode and a second current collector of the two or more current collectors is disposed adjacent to the second electrode.

In one aspect, at least one of the first and second current collector includes a first half including a first material, and a second half including a second material, where the second half is substantially parallel with the first half, and the first and second materials are different.

In one aspect, the solid-state battery may further include a polymer blocker, where the polymer blocker contacts the first current collector to the second current collector. The polymer blocker may have a thickness greater than or equal to about 2 μm to less than or equal to about 200 μm. The polymer blocker includes an insulating material selected from the group consisting of: urethane resin, polyamide resin, polyolefin resin, polyethylene resin, polypropylene resin, ethylene, propylene, butene, silicone, polyimide resin, epoxy resin, acrylic resin, ethylene-propylenediene rubber (EPDM), an isocyanate adhesive, an acrylic resin adhesive, a cyanoacrylate adhesive, and a combination thereof.

In one aspect, the solid-state battery may be a bipolar battery, where the two or more electrodes include a first electrode, a second electrode, and one or more bipolar electrodes, the plurality of solid-state electroactive particles includes a first plurality of solid-state electroactive particles and a second plurality of solid-state electroactive particles, and the one or more solid-state electrolyte layers include a first solid-state electrolyte layer and a second solid-state electrolyte layer. Each bipolar electrode may include a current collector. The first plurality of solid-state electroactive particles may be disposed on a first side of the current collector, and the second plurality of solid-state electroactive particles may be disposed on a second side of the current collector. The first solid-state electrolyte layer may be disposed between the first electrode and a first side of the one or more bipolar electrodes, and the second solid-state electrolyte may be disposed between a second side of the one or more bipolar electrodes and the second electrode. The ionogel may be further disposed within void spaces between the first plurality of solid-state electroactive particles and the second plurality of solid-state electroactive particles, the first solid-state electrolyte layer and the first electrode, the one or more bipolar electrodes, the one or more bipolar electrodes and the first solid-state electrolyte layer, the one or more bipolar electrodes and the second solid-state electrolyte layer, and the second solid-state electrolyte layer and the second electrode.

In various other aspects, the present disclosure provides a solid-state electrode including a plurality of solid-state electroactive particles, and an ionogel disposed within void spaces between the solid-state electroactive particles such that the solid-state electrode has an interparticle porosity of less than or equal to about 20 vol. %. The ionogel may have an ionic conductivity greater than or equal to about 0.1 mS/cm to less than or equal to about 10 mS/cm.

In one aspect, the plurality of solid-state electroactive particles may define an electrode layer. The solid-state electrode may further includes a solid-state electrolyte layer disposed adjacent to the electrode layer. The solid-state electrolyte layer may include a plurality of solid-state electrolyte particles. The ionogel may be further disposed within voids between the solid-state electrolyte particles and between the solid-state electrolyte layer and the electrode layer.

In one aspect, the ionogel may include greater than or equal to about 30 wt. % to less than or equal to about 95 wt. % of an ionic liquid and greater than or equal to about 2 wt. % to less than or equal to about 40 wt. % of a solid component. The ionic liquid may include a cation and an anion, and the solid component may include at least one of an organic polymer, an inorganic oxide, a polymer/oxide hybrid, and a metal-organic framework (MOFs).

In one aspect, the ionic liquid may include a cation selected from the group consisting of: Li(triglyme)methylimidazolium ([Li(G3)]⁺), Li(tetraglyme) ([Li(G4)⁺], 1-ethyl-3 ([Emim]⁺), 1-propyl-3-methylimidazolium ([Pmim]⁺), 1-butyl-3-methylimidazolium ([Bmim]⁺), 1,2-dimethyl-3-butylimidazolium ([DMBim]), 1-Alkyl-3-methylimidazolium ([Cnmim]⁺), 1-allyl-3-methylimidazolium ([Amim]⁺), 1,3-diallylimidazolium ([Daim]⁺), 1-allyl-3-vinylimidazolium ([Avim]⁺), 1-vinyl-3-ethylimidazolium ([Veim]⁺), 1-cyanomethyl-3-methylimidazolium ([MCNim]⁺); 1,3-dicyanomethyl-imidazolium ([BCNim]⁺), 1-propyl-1-methylpiperidinium ([PP₁₃]⁺), 1-butyl-1-methylpiperidinium ([PP₁₄]⁺), 1-methyl-1-ethylpyrrolidinium ([Pyr₁₂]⁺), 1-propyl-1-methylpyrrolidinium ([Pyr₁₃]⁺), 1-butyl-1-methylpyrrolidinium ([Pyr₁₄]⁺), methyl-methylcarboxymethyl-pyrrolidinium([MMMPyr]⁺), tetramethylammonium ([N₁₁₁₁]), tetraethylammonium ([N₂₂₂₂]⁺), tributylmethylammonium ([N₄₄₄₁]⁺), tiallyldimethylammonium ([DADMA]⁺); N—N-diethyl-N-methyl-N-(2-methoxyethyl)ammonium ([DEME]⁺), N,N-Diethyl-N-(2-methacryloylethyl)-N-methylammonium ([DEMM]⁺), trimethylisobutyl-phosphonium ([P₁₁₁ᵢ₄]⁺), triisobutylmethylphosphonium ([P₁ᵢ₄₄₄]⁺), tributylmethylphosphonium ([P₁₄₄₄]), diethylmethylisobutyl-phosphonium ([P₁₂₂₄]⁺), trihexdecylphosphonium ([P₆₆₆₁₀]⁺), trihexyltetradecylphosphonium ([P₆₆₆₁₄]⁺), and combinations thereof.

In one aspect, the ionic liquid may include an anion selected from the group consisting of: hexafluoroarsenate, hexafluorophosphate, bis(fluorosulfonyl)imide (FSI), bis(trifluoromethanesulfonyl(imide) (TFSI), perchlorate, tetrafluoroborate, cyclo-difluoromethane-1,1-bis(sulfonyl)imide (DMSI), bis(perfluoroethanesulfonyl)imide (BETI), bis(oxalate)borate (BOB), difluoro(oxalato)borate (DFOB), bis(fluoromalonato)boarate (BFMB), and combinations thereof.

In one aspect, the ionic liquid may further include a low-boiling point solvent. The low-boiling point solvent may be selected from the group consisting of: dimethyl carbonate, ethylene carbonate, ethyl acetate, acetonitrile, acetone, toluene, propylene carbonate, diethyl carbonate, 1,2,2-tetrafluoroethyl, 2,2,3,3-tetrafluoropropyl ether, and combinations thereof.

In one aspect, the ionogel may further include greater than 0 wt. % to less than about 40 wt. % of one or more lithium salts. Each lithium salt includes an anion selected from hexafluoroarsenate, hexafluorophosphate, bis(fluorosulfonyl)imide (FSI), perchlorate, tetrafluoroborate, cyclo-difluoromethane-1,1-bis(sulfonyl)imide (DMSI), bis(trifluoromethanesulfonyl)imide (TFSI), bis(perfluoroethanesulfonyl)imide (BETI), bis(oxalate)borate (BOB), difluoro(oxalato)borate (DFOB), and bis(fluoromalonato)borate (BFMB).

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1A is an illustration of an example solid-state battery;

FIG. 1B is an illustration of an example solid-state battery having an ionogel in accordance with various aspects of the current technology;

FIG. 2A is an illustration of an example negative electrode including a solid-state electrolyte layer disposed on an exposed surface thereof in accordance with various aspects of the current technology;

FIG. 2B is an illustration of an example positive electrode including a solid-state electrolyte layer disposed on an exposed surface thereof in accordance with various aspects of the current technology;

FIG. 2C is an illustration of an example solid-state battery where the solid-state electrolyte layer comprises a first solid-state electrolyte layer disposed on an exposed surface of the negative electrode and a second solid-state electrolyte layer disposed on an exposed surface of the positive electrode in accordance with various aspects of the current technology;

FIG. 3 is an illustration of an example method for forming an electrode having an ionogel in accordance with various aspects of the current technology;

FIG. 4A is an illustration of an example bipolar solid-state battery having ionogel in accordance with various aspects of the current technology;

FIG. 4B is an illustration of an example bipolar solid-state battery having ionogel and a dual current collector in accordance with various aspects of the current technology;

FIG. 4C is an illustration of an example bipolar solid-state battery having ionogel and a polymer blocker in accordance with various aspects of the current technology;

FIG. 5A is a graphical illustration of 1C charge-discharge plots of comparative cells; and

FIG. 5B is a graphical illustration of 1C cycling capabilities of comparative cells.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The current technology pertains to solid-state batteries (SSBs), for example bipolar solid-state batteries, that include ionogel. Solid-state batteries may have a bipolar stacking design comprising a plurality of bipolar electrodes where a first mixture of solid-state electroactive material particles (and optional solid-state electrolyte particles) is disposed on a first side of a current collector, and a second mixture of solid-state electroactive material particles (and optional solid-state electrolyte particles) is disposed on a second side of a current collector that is parallel with the first side. The first mixture may include, as the solid-state electroactive material particles, cathode material particles. The second mixture may include, as solid-state electroactive material particles, anode material particles. The solid-state electrolyte particles in each instance may be the same or different.

In each instance, ionogel may wet interfaces and/or fill void spaces between the solid-state electrolyte particles and/or the solid-state electroactive material particles so as to reduce interparticle porosity and improve ionic contact; and/or a polymer blocker may contact or connect one or more of the adjacent current collectors so as to mitigate potential ionic short-circuit. Such bipolar solid-state batteries may be incorporated into energy storage devices, like rechargeable lithium-ion batteries, which may be used in automotive transportation applications (e.g., motorcycles, boats, tractors, buses, mobile homes, campers, and tanks). The present technology, however, may also be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. In various aspects, the present disclosure provides a rechargeable lithium-ion battery that exhibits high temperature stability, as well as improved safety and superior power capability and life performance.

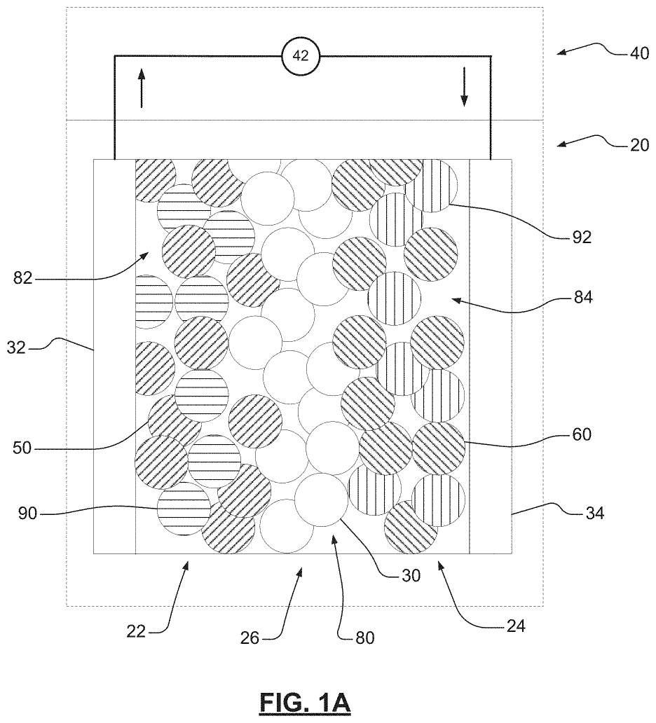

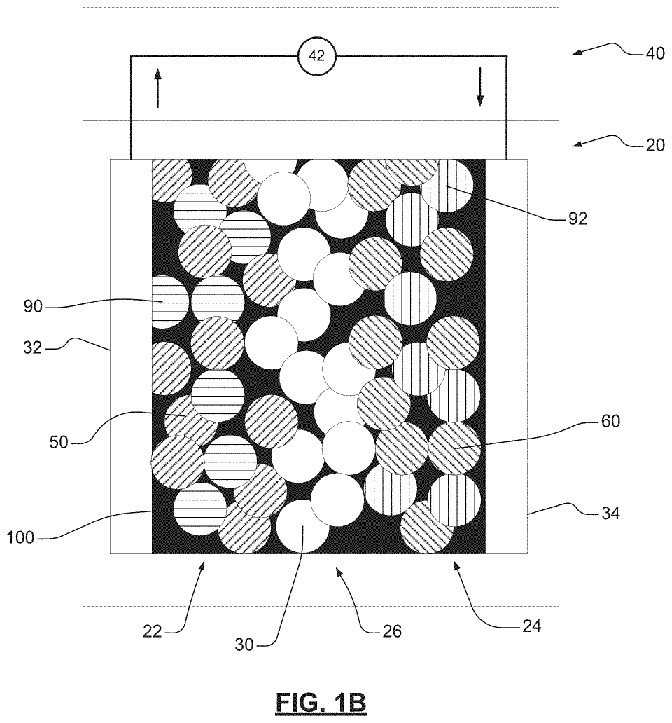

An exemplary and schematic illustration of an all-solid-state electrochemical cell (also referred to as “the solid-state battery” and/or “the battery”) 20 that cycles lithium ions is shown in each of FIGS. 1A and 1B. The battery 20 includes a negative electrode (i.e., anode) 22, a positive electrode (i.e., cathode) 24, and a solid-state electrolyte layer 26.

The solid-state electrolyte layer 26 is a separating layer that physically separates the negative electrode 22 from the positive electrode (i.e., cathode) 24. The solid-state electrolyte layer 26 may be defined by a first plurality of solid-state electrolyte particles 30. A second plurality of solid-state electrolyte particles 90 may be mixed with negative solid-state electroactive particles 50 in the negative electrode 22, and a third plurality of solid-state electrolyte particles 92 may be mixed with positive solid-state electroactive particles 60 in the positive electrode 24 to form a continuous electrolyte network, which may be a continuous solid-state electrolyte network. For example, the negative solid-state electroactive particles 50 and the positive solid-state electroactive particles 60 are independently mixed with no electrolyte, or with the second/third plurality of solid-state electrolyte particles 90, 92.

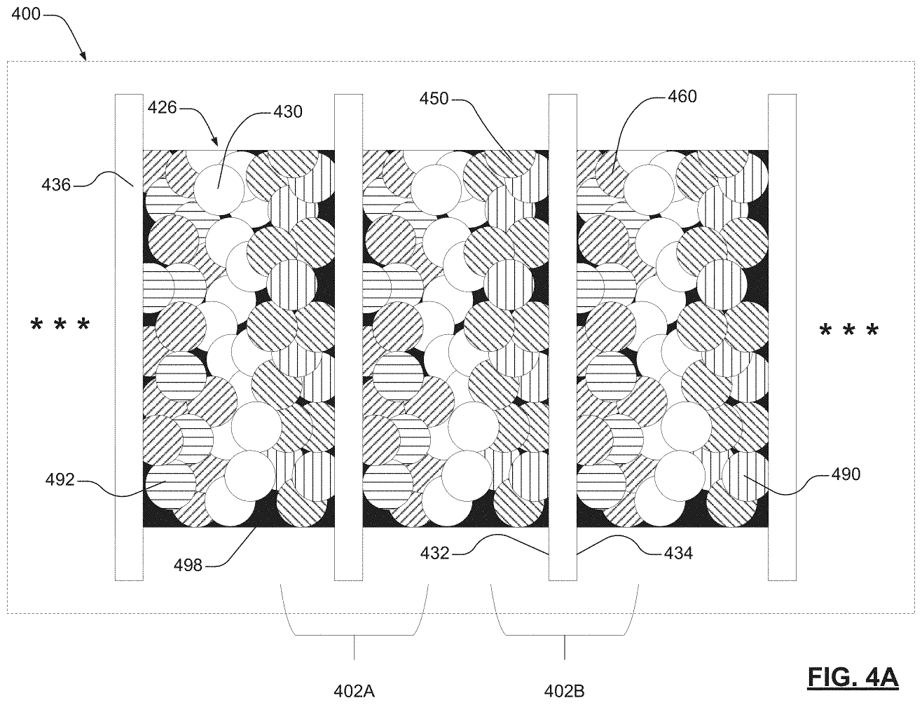

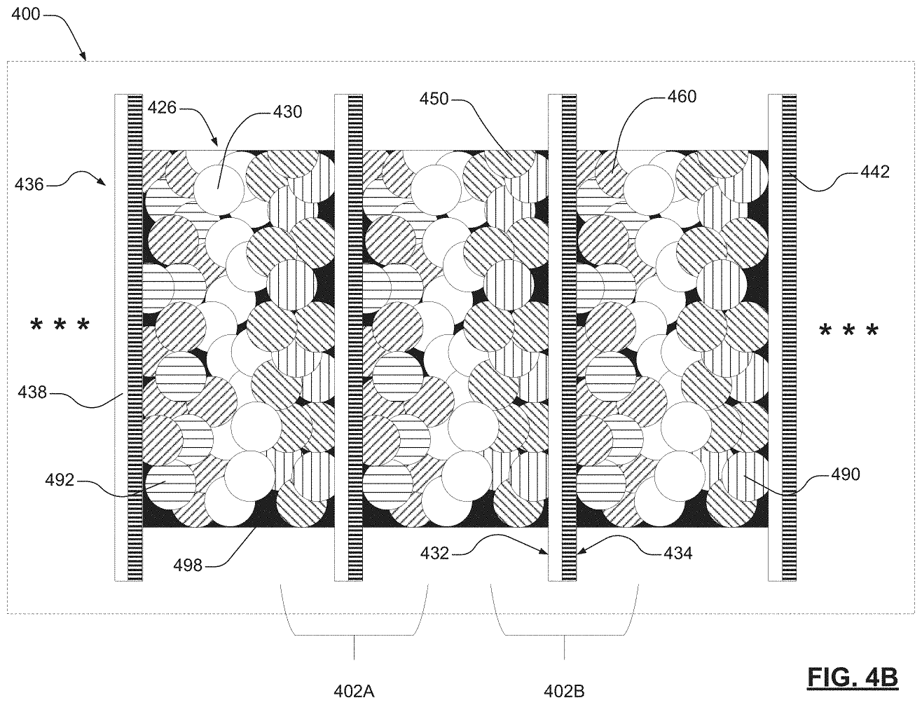

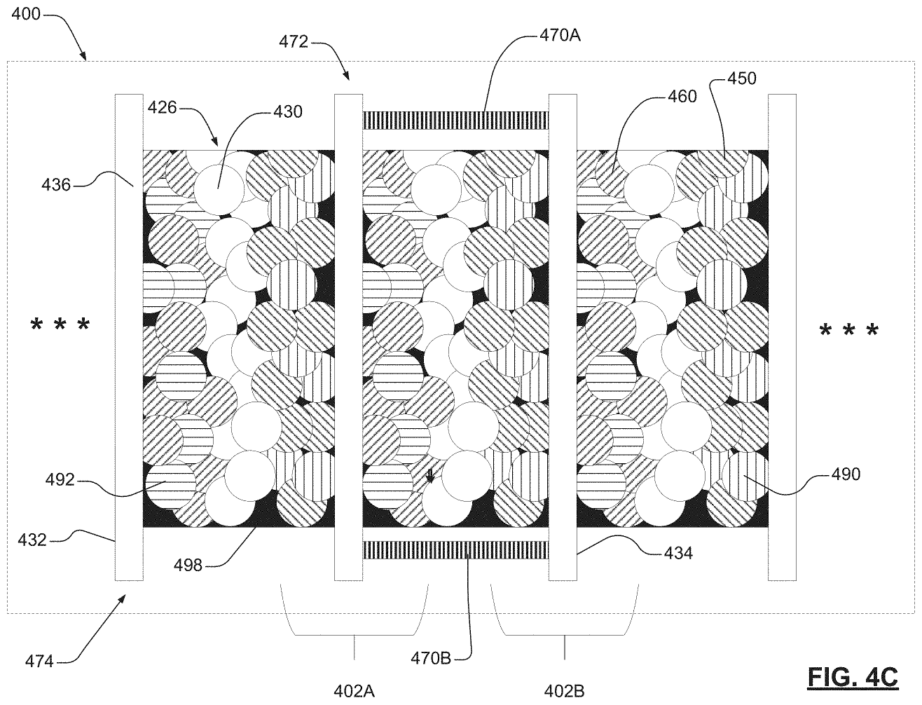

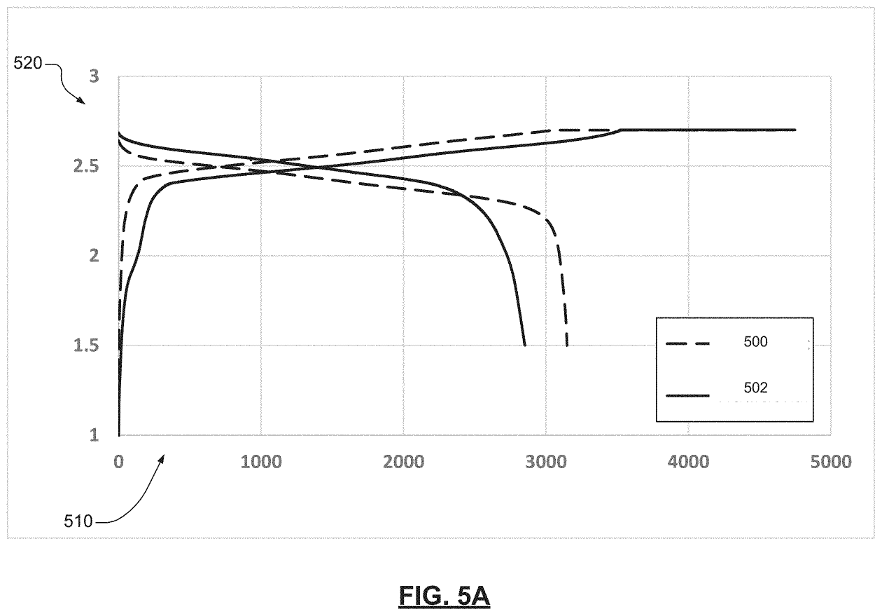

A negative electrode current collector 32 may be positioned at or near the negative electrode 22. The negative electrode current collector 32 may be formed from copper or any other appropriate electrically conductive material known to those of skill in the art, such as discussed below in the context of FIG. 4B. A positive electrode current collector 34 may be positioned at or near the positive electrode 24. The positive electrode current collector 34 may be formed from aluminum or any other electrically conductive material known to those of skill in the art, such as discussed below in the context of FIG. 4B. The negative electrode current collector 32 and the positive electrode current collector 34 respectively collect and move free electrons to and from an external circuit 40 (as shown by the block arrows). For example, an interruptible external circuit 40 and a load device 42 may connect the negative electrode 22 (through the negative electrode current collector 32) and the positive electrode 24 (through the positive electrode current collector 34).

Though the illustrated example includes a single positive electrode (i.e., cathode) 24 and a single negative electrode (i.e., anode) 22, the skilled artisan will recognize that the current teachings apply to various other configurations, including those having one or more cathodes and one or more anodes, as well as various current collectors with electroactive particle layers disposed on or adjacent to one or more surfaces thereof.

The battery 20 can generate an electric current (indicated by arrows in FIGS. 1A and 1B) during discharge by way of reversible electrochemical reactions that occur when the external circuit 40 is closed (to connect the negative electrode 22 and the positive electrode 24) and when the negative electrode 22 has a lower potential than the positive electrode 24. The chemical potential difference between the negative electrode 22 and the positive electrode 24 drives electrons produced by a reaction, for example, the oxidation of intercalated lithium, at the negative electrode 22, through the external circuit 40 towards the positive electrode 24. Lithium ions, which are also produced at the negative electrode 22, are concurrently transferred through the solid-state electrolyte layer 26 towards the positive electrode 24. The electrons flow through the external circuit 40 and the lithium ions migrate across the solid-state electrolyte layer 26 to the positive electrode 24, where they may be plated, reacted, or intercalated. The electric current passing through the external circuit 40 can be harnessed and directed through the load device 42 (in the direction of the arrows) until the lithium in the negative electrode 22 is depleted and the capacity of the battery 20 is diminished.

The battery 20 can be charged or reenergized at any time by connecting an external power source (e.g., charging device) to the battery 20 to reverse the electrochemical reactions that occur during battery discharge. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator. The connection of the external power source to the battery 20 promotes a reaction, for example, non-spontaneous oxidation of intercalated lithium, at the positive electrode 24 so that electrons and lithium ions are produced. The electrons, which flow back towards the negative electrode 22 through the external circuit 40, and the lithium ions, which move across the solid-state electrolyte layer 26 back towards the negative electrode 22, reunite at the negative electrode 22 and replenish it with lithium for consumption during the next battery discharge cycle. As such, a complete discharging event followed by a complete charging event is considered to be a cycle, where lithium ions are cycled between the positive electrode 24 and the negative electrode 22.

In many of the configurations of the battery 20, each of the negative electrode current collector 32, the negative electrode 22, the solid-state electrolyte layer 26, the positive electrode 24, and the positive electrode current collector 34 are prepared as relatively thin layers (for example, from several microns to a millimeter or less in thickness) and assembled in layers connected in electrical parallel arrangement to provide a suitable electrical energy and power package. In various other instances, the battery 20 may include electrodes 22, 24 connected in series.

In various aspects, the battery 20 may include a variety of other components that, while not depicted here, are nonetheless known to those of skill in the art. For example, the battery 20 may include a casing, a gasket, terminal caps, and any other conventional components or materials that may be situated within the battery 20, including between or around the negative electrode 22, the positive electrode 24, and/or the solid-state electrolyte layer 26.

As noted above, the size and shape of the battery 20 may vary depending on the particular applications for which it is designed. Battery-powered vehicles and hand-held consumer electronic devices are two examples where the battery 20 would most likely be designed to different size, capacity, and power-output specifications. As noted above, the battery 20 may also be connected in series or parallel with other similar lithium-ion cells or batteries to produce a greater voltage output, energy, and power if it is required by the load device 42. The battery 20 can generate an electric current to the load device 42 that can be operatively connected to the external circuit 40. The load device 42 may be fully or partially powered by the electric current passing through the external circuit 40 when the battery 20 is discharging. While the load device 42 may be any number of known electrically-powered devices, a few specific examples of power-consuming load devices include an electric motor for a hybrid vehicle or an all-electric vehicle, a laptop computer, a tablet computer, a cellular phone, and cordless power tools or appliances, by way of non-limiting example. The load device 42 may also be an electricity-generating apparatus that charges the battery 20 for purposes of storing electrical energy.

With renewed reference to FIGS. 1A and 1B, the solid-state electrolyte layer 26 provides electrical separation-preventing physical contact-between the negative electrode 22 (i.e., an anode) and the positive electrode 24 (i.e., a cathode). The solid-state electrolyte layer 26 also provides a minimal resistance path for internal passage of ions. In various aspects, as noted above, the solid-state electrolyte layer 26 may be defined by a first plurality of solid-state electrolyte particles 30. For example, the solid-state electrolyte layer 26 may be in the form of a layer or a composite that comprises the first plurality of solid-state electrolyte particles 30. The solid-state electrolyte particles 30 may have an average particle diameter greater than or equal to about 0.02 μm to less than or equal to about 20 μm, and in certain aspects, optionally greater than or equal to about 0.1 μm to less than or equal to about 1 μm. Though not illustrated, the skilled artisan will recognized that in certain instances, one or more binder particles may be mixed with the solid-state electrolyte particles 30. For example, in certain aspects the solid-state electrolyte layer 26 may include greater than or equal to about 0.5 wt. % to less than or equal to about 10 wt. % of the one or more binder. The one or more binders may include, for example only, polyvinylidene difluoride (PVDF), polytetrafluoroethylene (PTFE), ethylene propylene diene monomer (EPDM) rubber, nitrile butadiene rubber (NBR), styrene-butadiene rubber (SBR), and lithium polyacrylate (LiPAA).

The solid-state electrolyte layer 26 may be in the form of a layer having a thickness greater than or equal to about 5 μm to less than or equal to about 200 μm, optionally greater than or equal to about 10 μm to less than or equal to about 100 μm, optionally about 40 μm, and in certain aspects, optionally about 20 μm. Such solid-state electrolyte layers 26 may have, as illustrated in FIG. 1A, an interparticle porosity 80 (defined herein as a fraction of the total volume of pores over the total volume of the layer or film being described) between the first plurality of solid-state electrolyte particles 30 that is greater than 0 vol. % to less than or equal to about 50 vol. %, greater than or equal to about 1 vol. % to less than or equal to about 40 vol. %, or greater than or equal to about 2 vol. % to less than or equal to about 20 vol. %.

The first plurality of solid-state electrolyte particles 30 may comprise one or more oxide-based particles, metal-doped or aliovalent-substituted oxide particles, sulfide-based particles, nitride-based particles, hydride-based particles, halide-based particles, and borate-based particles.

In certain variations, the oxide-based particles may comprise one or more garnet ceramics, LISICON-type oxides, NASICON-type oxides, and Perovskite type ceramics. For example, the garnet ceramics may be selected from the group consisting of: Li₇La₃Zr₂O₁₂, Li_{6.2}Ga_{0.3}La_{2.95}Rb_{0.05}Zr₂O₁₂, Li_{6.85}La_{2.9}Ca_{0.1}Zr_{1.75}Nb_{0.25}O₁₂, Li_{6.25}Al_{0.25}La₃Zr₂O₁₂, Li_{6.75}La₃Zr_{1.75}Nb_{0.25}O₁₂, and combinations thereof. The LISICON-type oxides may be selected from the group consisting of: Li₂₊₂ₓZn₁₋ₓGeO₄ (where 0<x<1), Li₁₄Zn(GeO₄)₄, Li₃₊ₓ(P₁₋ₓSiₓ)O₄ (where 0<x<1), Li₃₊ₓGeₓV₁₋ₓO₄ (where 0<x<1), and combinations thereof. The NASICON-type oxides may be defined by LiMM′(PO₄)₃, where M and M′ are independently selected from Al, Ge, Ti, Sn, Hf, Zr, and La. For example, in certain variations, the NASICON-type oxides may be selected from the group consisting of: Li₁₊ₓAlₓGe₂₋ₓ(PO₄)₃ (LAGP) (where 0≤x≤2), Li_{1.4}Al_{0.4}Ti_{1.6}(PO₄)₃, Li_{1.3}Al_{0.3}Ti_{1.7}(PO₄)₃, LiTi₂(PO₄)₃, LiGeTi(PO₄)₃, LiGe₂(PO₄)₃, LiHf₂(PO₄)₃, and combinations thereof. The Perovskite-type ceramics may be selected from the group consisting of: Li_{3.3}La_{0.53}TiO₃, LiSr_{1.65}Zr_{1.3}Ta_{1.7}O₉, Li_{2x-y}Sr₁₋ₓTa_{y}Zr_{1-y}O₃ (where x=0.75y and 0.60<y<0.75), Li_{3/8}Sr_{7/16}Nb_{3/4}Zr_{1/4}O₃, Li₃ₓLa_{(2/3-x)}TiO₃ (where 0<x<0.25), and combinations thereof.

In certain variations, the metal-doped or aliovalent-substituted oxide particles may include, for example only, aluminum (Al) or niobium (Nb) doped Li₇La₃Zr₂O₁₂, antimony (Sb) doped Li₇La₃Zr₂O₁₂, gallium (Ga) doped Li₇La₃Zr₂O₁₂, chromium (Cr) and/or vanadium (V) substituted LiSn₂P₃O₁₂, aluminum (Al) substituted Li_{1+x+y}AlₓTi₂₋ₓSi_{Y}P_{3-y}O₁₂ (where 0<x<2 and 0<y<3), and combinations thereof.

In certain variations, the sulfide-based particles may include, for example only, Li₂S—P₂S₅ system, Li₂S—P₂S₅-MOₓ system (where 1<x<7), Li₂S—P₂S₅-MSₓ system (where 1<x<7), Li₁₀GeP₂S₁₂ (LGPS), Li₆PS₅X (where X is Cl, Br, or I) (lithium argyrodite), Li₇P₂S₈I, Li_{10.35}Ge_{1.35}P_{1.65}S₁₂, Li_{3.25}Ge_{0.25}P_{0.75}S₄ (thio-LISICON), Li₁₀SnP₂S₁₂, Li₁₀SiP₂S₁₂, Li_{9.54}S_{1.74}P_{1.44}S_{11.7}Cl_{0.3}, (1−x)P₂S₅-xLi₂S (where 0.5≤x≤0.7), Li_{3.4}Si_{0.4}P_{0.6}S₄, PLi₁₀GeP₂S_{11.7}O_{0.3}, Li_{9.6}P₃S₁₂, Li₇P₃S₁₁, Li₉P₃S₉O₃, Li_{10.35}Ge_{1.35}P_{1.63}S₁₂, Li_{9.81}Sn_{0.81}P_{2.19}S₁₂, Li₁₀(Si_{0.5}Ge_{0.5})P₂S₁₂, Li₁₀(Ge_{0.5}Sn_{0.5})P₂S₁₂, Li₁₀(Si_{0.5}Sn_{0.5})P₂S₁₂, Li_{3.833}Sn_{0.833}As_{0.16}S₄, LiI—Li₄SnS₄, Li₄SnS₄, and combinations thereof.

In certain variations, the nitride-based particles may include, for example only, Li_{3N}, Li₇PN₄, LiSi₂N₃, and combinations thereof; the hydride-based particles may include, for example only, LiBH₄, LiBH₄—LiX (where x=Cl, Br, or I), LiNH₂, Li₂NH, LiBH₄—LiNH₂, Li₃AlH₆, and combinations thereof; the halide-based particles may include, for example only, LiI, Li₃InCl₆, Li₂CdC₁₄, Li₂MgCl₄, LiCdI₄, Li₂ZnI₄, Li₃OCl, and combinations thereof; and the borate-based particles may include, for example only, Li₂B₄O₇, Li₂O—B₂O₃—P₂O₅, and combinations thereof.

In this manner, in various aspects, the first plurality of solid-state electrolyte particles 30 may include one or more electrolyte materials selected from the group consisting of: Li₇La₃Zr₂O₁₂, Li_{6.2}Ga_{0.3}La_{2.95}Rb_{0.05}Zr₂O₁₂, Li_{6.85}La_{2.9}Ca_{0.1}Zr_{1.75}Nb_{0.25}O₁₂, Li_{6.25}Al_{0.25}La₃Zr₂O₁₂, Li_{6.75}La₃Zr_{1.75}Nb_{0.25}O₁₂, Li_{6.75}La₃Zr_{1.75}Nb_{0.25}O₁₂, Li₂₊₂ₓZn₁₋ₓGeO₄ (where 0<x<1), Li₁₄Zn(GeO₄)₄, Li₃₊ₓ(P₁₋ₓSiₓ)O₄ (where 0<x<1), Li₃₊ₓGeₓV₁₋ₓO₄ (where 0<x<1), LiMM′(PO₄)₃ (where M and M′ are independently selected from Al, Ge, Ti, Sn, Hf, Zr, and La), Li_{3.3}La_{0.53}TiO₃, LiS_{1.65}Zr_{1.3}Ta_{1.7}O₉, Li_{2x-y}Sr₁₋ₓTa_{y}Zr_{1-y}O₃ (where x=0.75y and 0.60<y<0.75), Li_{3/8}Sr_{7/16}Nb_{3/4}Zr_{1/4}O₃, Li₃ₓLa_{(2/3-x)}TiO₃ (where 0<x<0.25), aluminum (Al) or niobium (Nb) doped Li₇La₃Zr₂O₁₂, antimony (Sb) doped Li₇La₃Zr₂O₁₂, gallium (Ga) doped Li₇La₃Zr₂O₁₂, chromium (Cr) and/or vanadium (V) substituted LiSn₂P₃O₁₂, aluminum (Al) substituted Li_{1+x+y}AlₓTi₂₋ₓSi_{Y}P_{3-y}O₁₂ (where 0<x<2 and 0≤y≤3), Li₂S—P₂S₅ system, Li₂S—P₂S₅-MOₓ system (where 1<x<7), Li₂S—P₂S₅-MSₓ system (where 1<x<7), Li₁₀GeP₂S₁₂ (LGPS), Li₆PS₅X (where X is Cl, Br, or I) (lithium argyrodite), Li₇P₂S₈I, Li_{10.35}Ge_{1.35}P_{1.65}S₁₂, Li_{3.25}Ge_{0.25}P_{0.75}S₄ (thio-LISICON), Li₁₀SnP₂S₁₂, Li₁₀SiP₂S₁₂, Li_{9.54}Si_{1.74}P_{1.44}S_{11.7}Cl_{0.3}, (1−x)P₂S₅₋ₓLi₂S (where 0.5≤x≤0.7), Li_{3.4}Si_{0.4}P_{0.6}S₄, PLi₁₀GeP₂S_{11.7}O_{0.3}, Li_{9.6}P₃S₁₂, Li₇P₃S₁₁, Li₉P₃S₉O₃, Li_{10.35}Ge_{1.35}P_{1.63}S₁₂, Li_{9.81}Sn_{0.81}P_{2.19}S₁₂, Li₁₀(Si_{0.5}Ge_{0.5})P₂S₁₂, Li₁₀(Ge_{0.5}Sn_{0.5})P₂S₁₂, Li₁₀(Si_{0.5}Sn_{0.5})P₂S₁₂, Li_{3.833}Sn_{0.833}As_{0.16}S₄, LiI—Li₄SnS₄, Li₄SnS₄, Li₃N, Li₇PN₄, LiSi₂N₃, LiBH₄, LiBH₄—LiX (where x=Cl, Br, or I), LiNH₂, Li₂NH, LiBH₄—LiNH₂, Li₃AlH₆, LiI, Li₃InCl₆, Li₂CdC₁₄, Li₂MgCl₄, LiCdI₄, Li₂ZnI₄, Li₃OCl, Li₂B₄O₇, Li₂O—B₂O₃—P₂O₅, and combinations thereof.

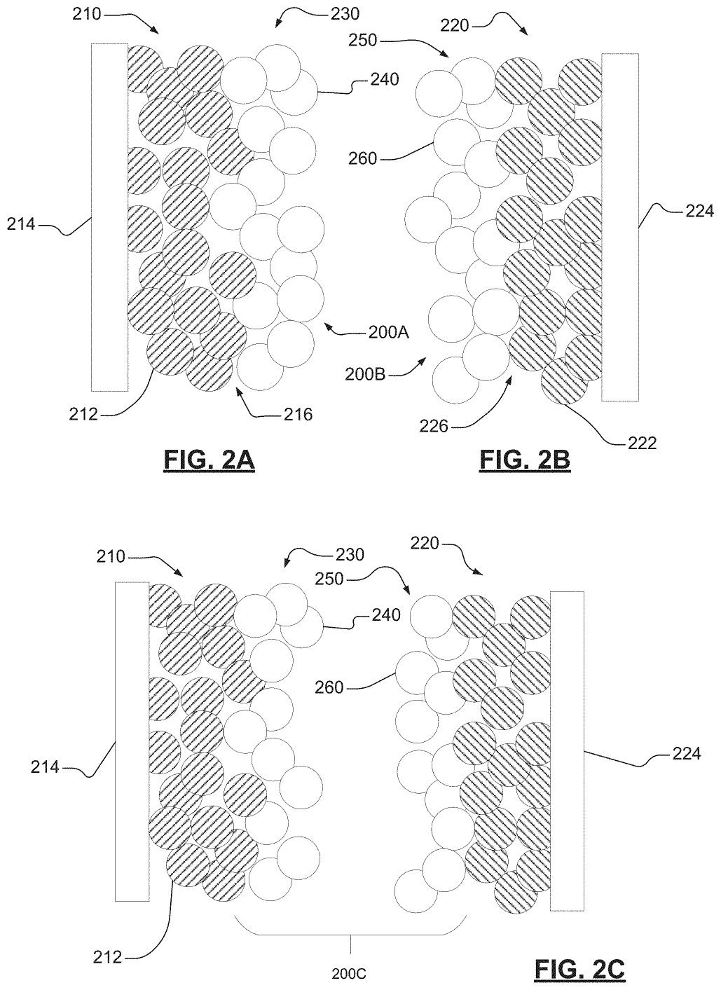

In various aspects, as illustrated in FIGS. 2A-2C, solid-state electrolyte layers 200A, 200B, 200C for use within a solid-state battery, such as described in the context of FIGS. 1A and 1B, may be formed, respectively, by a single(first) layer 230 comprising a first plurality of solid-state electrolyte particles 240 that is disposed on an exposed surface 216 of a negative electrode 210 (i.e., anode), which is defined by a plurality of negative solid-state electroactive particles 212 (and in certain instances, as discussed above, another plurality of solid-state electrolyte particles (not shown)) that are disposed adjacent to a negative electrode current collector 214; a single (second) layer 250 comprising a second plurality of solid-state electrolyte particles 260 that is disposed on an exposed surface 226 of a positive electrode 220 (i.e., cathode), which is defined by a plurality of positive solid-state electroactive particles 222 (and in certain instances, as discussed above, another plurality of solid-state electrolyte particles (not shown)) that are disposed adjacent to a positive electrode current collector 224; or a combination thereof—that is, a first layer 230 comprising the first plurality of solid-state electrolyte particles 240 disposed on the negative electrode 210 and a second layer 250 comprising the second plurality of solid-state electrolyte particles 260 disposed on the positive electrode 220.

In each instance, the solid-state electrolyte particles 240, 260 may comprise one or more of the solid-state electrolyte materials such as detailed above. The solid-state electrolyte materials defining each layer 230, 250 may be the same or different. Each of the solid-state electrolyte layers 200A, 200B, 200C may have a thickness greater than or equal to about 5 μm to less than or equal to about 200 μm, optionally greater than or equal to about 10 μm to less than or equal to about 100 μm, optionally about 40 μm, and in certain aspects, optionally about 20 μm. The first and second layers 230, 250 have thicknesses so as to define solid-state electrolyte layers 200A, 200B, 200C having thicknesses greater than or equal to about 5 μm to less than or equal to about 200 μm, optionally greater than or equal to about 10 μm to less than or equal to about 100 μm, optionally about 40 μm, and in certain aspects, optionally about 20 μm.

With renewed reference to FIGS. 1A and 1B, the negative electrode 22 may be formed from a lithium host material that is capable of functioning as a negative terminal of a lithium-ion battery. For example, in certain variations, the negative electrode 22 may be defined by a plurality of the negative solid-state electroactive particles 50. In certain instances, as illustrated, the negative electrode 22 is a composite comprising a mixture of the negative solid-state electroactive particles 50 and the second plurality of solid-state electrolyte particles 90. For example, the negative electrode 22 may include greater than or equal to about 30 wt. % to less than or equal to about 98 wt. %, and in certain aspects, optionally greater than or equal to about 50 wt. % to less than or equal to about 95 wt. %, of the negative solid-state electroactive particles 50 and greater than or equal to about 0 wt. % to less than or equal to about 50 wt. %, and in certain aspects, optionally greater than or equal to about 5 wt. % to less than or equal to about 20 wt. %, of the second plurality of solid-state electrolyte particles 90. Such negative electrodes 22 may have an interparticle porosity 82 between the negative solid-state electroactive particles 50 and/or the second plurality of solid-state electrolyte particles 90, such as illustrated in FIG. 1A, that is greater than or equal to about 0 vol. % to less than or equal to about 20 vol. %.

The second plurality of solid-state electrolyte particles 90 may be the same as or different from the first plurality of solid-state electrolyte particles 30. In certain variations, the negative solid-state electroactive particles 50 may be lithium-based, for example, a lithium alloy. In other variations, the negative solid-state electroactive particles 50 may be silicon-based comprising, for example, a silicon alloy and/or silicon-graphite mixture. In still other variations, the negative electrode 22 may be a carbonaceous anode and the negative solid-state electroactive particles 50 may comprise one or more negative electroactive materials, such as graphite, graphene, hard carbon, soft carbon, and carbon nanotubes (CNTs). In still further variations, the negative electrode 22 may comprise one or more negative electroactive materials, such as lithium titanium oxide (Li₄Ti₅O₁₂); one or more metal oxides, such as TiO₂ and/or V₂O₅; and metal sulfides, such as FeS. Thus, the negative solid-state electroactive particles 50 may be selected from the group including, for example only, lithium, graphite, graphene, hard carbon, soft carbon, carbon nanotubes, silicon, silicon-containing alloys, tin-containing alloys, and combinations thereof.

In certain variations, the negative electrode 22 may further include one or more conductive additives and/or binder materials. For example, the negative solid-state electroactive particles 50 (and/or second plurality of solid-state electrolyte particles 90) may be optionally intermingled with one or more electrically conductive materials (not shown) that provide an electron conduction path and/or at least one polymeric binder material (not shown) that improves the structural integrity of the negative electrode 22.

For example, the negative solid-state electroactive particles 50 (and/or second plurality of solid-state electrolyte particles 90) may be optionally intermingled with binders, such as polyvinylidene difluoride (PVDF), polytetrafluoroethylene (PTFE), ethylene propylene diene monomer (EPDM) rubber, nitrile butadiene rubber (NBR), styrene-butadiene rubber (SBR), and/or lithium polyacrylate (LiPAA) binders. Electrically conductive materials may include, for example, carbon-based materials or a conductive polymer. Carbon-based materials may include, for example, particles of graphite, acetylene black (such as KETCHEN™ black or DENKA™ black), carbon fibers and nanotubes, graphene (such as graphene oxide), carbon black (such as Super P), and the like. Examples of a conductive polymer may include polyaniline, polythiophene, polyacetylene, polypyrrole, and the like. In certain aspects, mixtures of the conductive additives and/or binder materials may be used.

The negative electrode 22 may include greater than or equal to about 0 wt. % to less than or equal to about 30 wt. %, and in certain aspects, optionally greater than or equal to about 2 wt. % to less than or equal to about 10 wt. %, of the one or more electrically conductive additives; and greater than or equal to about 0 wt. % to less than or equal to about 20 wt. %, and in certain aspects, optionally greater than or equal to about 1 wt. % to less than or equal to about 10 wt. %, of the one or more binders.

The positive electrode 24 may be formed from a lithium-based or electroactive material that can undergo lithium intercalation and deintercalation while functioning as the positive terminal of the battery 20. For example, in certain variations, the positive electrode 24 may be defined by a plurality of the positive solid-state electroactive particles 60. In certain instances, as illustrated, the positive electrode 24 is a composite comprising a mixture of the positive solid-state electroactive particles 60 and the third plurality of solid-state electrolyte particles 92. For example, the positive electrode 24 may include greater than or equal to about 30 wt. % to less than or equal to about 98 wt. %, and in certain aspects, optionally greater than or equal to about 50 wt. % to less than or equal to about 95 wt. %, of the positive solid-state electroactive particles 60 and greater than or equal to about 0 wt. % to less than or equal to about 50 wt. %, and in certain aspects, optionally greater than or equal to about 5 wt. % to less than or equal to about 20 wt. %, of the third plurality of solid-state electrolyte particles 92. Such positive electrodes 24 may have an interparticle porosity 84 between the positive solid-state electroactive particles 60 and/or the third plurality of solid-state electrolyte particles 92, such as illustrated in FIG. 1A, that is greater than or equal to about 1 vol. % to less than or equal to about 20 vol. %, and optionally greater than or equal to 5 vol. % to less than or equal to about 10 vol. %.

The third plurality of solid-state electrolyte particles 92 may be the same as or different from the first and/or second pluralities of solid-state electrolyte particles 30, 90. In certain variations, the positive electrode 24 may be one of a layered-oxide cathode, a spinel cathode, and a polyanion cathode. For example, in the instances of a layered-oxide cathode (e.g., rock salt layered oxides), the positive solid-state electroactive particles 60 may comprise one or more positive electroactive materials selected from LiCoO₂, LiNiₓMn_{y}Co_{1-x-y}O₂ (where 0≤x≤1 and 0≤y≤1), LiNiₓMn_{y}Al_{1-x-y}O₂ (where 0<x≤1 and 0<y≤1), LiNiₓMn₁₋ₓO₂ (where 0≤x≤1), and Li₁₊ₓMO₂ (where 0≤x≤1) for solid-state lithium-ion batteries. The spinel cathode may include one or more positive electroactive materials, such as LiMn₂O₄ and LiNi_{0.5}Mn_{1.5}O₄. The polyanion cation may include, for example, a phosphate, such as LiFePO₄, LiVPO₄, LiV₂(PO₄)₃, Li₂FePO₄F, Li₃Fe₃(PO₄)₄, or Li₃V₂(PO₄)F₃ for lithium-ion batteries, and/or a silicate, such as LiFeSiO₄ for lithium-ion batteries. In this fashion, in various aspects, the positive solid-state electroactive particles 60 may comprise one or more positive electroactive materials selected from the group consisting of LiCoO₂, LiNiₓMn_{y}Co_{1-x-y}O₂ (where 0≤x≤1 and 0≤y≤1), LiNiₓMn₁₋ₓO₂ (where 0≤x≤1), Li₁₊ₓMO₂(where 0≤x≤1), LiMn₂O₄, LiNiₓMn_{1.5}O₄, LiFePO₄, LiVPO₄, LiV₂(PO₄)₃, Li₂FePO₄F, Li₃Fe₃(PO₄)₄, Li₃V₂(PO₄)F₃, LiFeSiO₄, and combinations thereof. In certain aspects, the positive solid-state electroactive particles 60 may be coated (for example, by LiNbO₃ and/or Al₂O₃) and/or the positive electroactive material may be doped (for example, by aluminum and/or magnesium).

In certain variations, the positive electrode 24 may further include one or more conductive additives and/or binder materials. For example, the positive solid-state electroactive particles 60 (and/or third plurality of solid-state electrolyte particles 92) may be optionally intermingled with one or more electrically conductive materials (not shown) that provide an electron conduction path and/or at least one polymeric binder material (not shown) that improves the structural integrity of the positive electrode 24.

For example, the positive solid-state electroactive particles 60 (and/or third plurality of solid-state electrolyte particles 92) may be optionally intermingled with binders, like polyvinylidene difluoride (PVDF), polytetrafluoroethylene (PTFE), ethylene propylene diene monomer (EPDM) rubber, nitrile butadiene rubber (NBR), styrene-butadiene rubber (SBR), and/or lithium polyacrylate (LiPAA) binders. Electrically conductive materials may include, for example, carbon-based materials or a conductive polymer. Carbon-based materials may include, for example, particles of graphite, acetylene black (such as KETCHEN™ black or DENKA™ black), carbon fibers and nanotubes, graphene (such as graphene oxide), carbon black (such as Super P), and the like. Examples of a conductive polymer may include polyaniline, polythiophene, polyacetylene, polypyrrole, and the like. In certain aspects, mixtures of the conductive additives and/or binder materials may be used.

The positive electrode 24 may include greater than or equal to about 0 wt. % to less than or equal to about 30 wt. %, and in certain aspects, optionally greater than or equal to about 2 wt. % to less than or equal to about 10 wt. %, of the one or more electrically conductive additives; and greater than or equal to about 0 wt. % to less than or equal to about 20 wt. %, and in certain aspects, optionally greater than or equal to about 1 wt. % to less than or equal to about 10 wt. %, of the one or more binders.

As a result of the interparticle porosity 80, 82, 84 between particles within the battery 20 (for example, the battery 20 in a green form may have a solid-state electrolyte interparticle porosity greater than or equal to about 0 vol. % to less than or equal to about 30 vol. %), direct contact between the solid-state electroactive particles 50, 60 and the pluralities of solid-state electrolyte particles 30, 90, 92 may be much lower than the contact between a liquid electrolyte and solid-state electroactive particles in comparable non-solid-state batteries. In various aspects, such as illustrated in FIG. 1B, the present disclosure provides an ionogel 100. Ionogel 100 may be disposed within the battery so as to wet interfaces and/or fill void spaces between the solid-state electrolyte particles 50, 60 and/or the solid-state active material particles 30, 90, 92 so as to, for example only, reduce interparticle porosity 80, 82, 84 and improve ionic contact and/or enable higher thermal stability. The battery 20 may include greater than or equal to about 0 wt. % to less than or equal to about 30 wt. %, and in certain aspects, greater than or equal to about 5 wt. % to less than or equal to about 20 wt. %, of the ionogel 100.

The ionogel 100 is a soft ionogel formed by immobilizing an ionic liquid in a solid component, such that the ionogel 100 retains the properties of the ionic liquid. For example, the ionogel 100 may have an ionic conductivity greater than or equal to about 0.1 mS/cm to less than or equal to about 10 mS/cm, optionally greater than or equal to about 1 mS/cm to less than or equal to about 10 mS/cm, and in certain aspects, optionally about 1 mS/cm and a decomposition temperature greater than about 200° C. The ionogel 100 may include, for example, greater than or equal to about 30 wt. % to less than or equal to about 98 wt. %, and in certain aspects, optionally greater than or equal to about 50 wt. % to less than or equal to about 95 wt. %, of the ionic liquid; greater than or equal to about 2 wt. % to less than or equal to about 40 wt. %, and in certain aspects, optionally greater than or equal to about 5 wt. % to less than or equal to about 20 wt. %, of the solid component.

The ionic liquid comprises, for example, a cation and an anion, and in certain variations, an optional dilute solvent.

The cation may include, for example only, Li(triglyme)methylimidazolium ([Li(G3)]⁺), Li(tetraglyme) ([Li(G4)⁺], 1-ethyl-3 ([Emim]⁺), 1-propyl-3-methylimidazolium ([Pmim]⁺), 1-butyl-3-methylimidazolium ([Bmim]⁺), 1,2-dimethyl-3-butylimidazolium ([DMBim]), 1-Alkyl-3-methylimidazolium ([Cnmim]⁺), 1-allyl-3-methylimidazolium ([Amim]⁺), 1,3-diallylimidazolium ([Daim]⁺), 1-allyl-3-vinylimidazolium ([Avim]⁺), 1-vinyl-3-ethylimidazolium ([Veim]⁺), 1-cyanomethyl-3-methylimidazolium ([MCNim]⁺); 1,3-dicyanomethyl-imidazolium ([BCNim]⁺), 1-propyl-1-methylpiperidinium ([PP₁₃]⁺), 1-butyl-1-methylpiperidinium ([PP₁₄]⁺), 1-methyl-1-ethylpyrrolidinium ([Pyr₁₂]⁺), 1-propyl-1-methylpyrrolidinium ([Pyr₁₃]⁺), 1-butyl-1-methylpyrrolidinium ([Pyr₁₄]⁺), methyl-methylcarboxymethyl-pyrrolidinium([MMMPyr]⁺), tetramethylammonium ([N₁₁₁₁]), tetraethylammonium ([N₂₂₂₂]⁺), tributylmethylammonium ([N₄₄₄₁]⁺), tiallyldimethylammonium ([DADMA]⁺), N—N-diethyl-N-methyl-N-(2-methoxyethyl)ammonium ([DEME]⁺), N,N-Diethyl-N-(2-methacryloylethyl)-N-methylammonium ([DEMM]⁺), trimethylisobutyl-phosphonium ([P₁₁₁ᵢ₄]⁺), triisobutylmethylphosphonium ([P₁ᵢ₄₄₄]⁺), tributylmethylphosphonium ([P₁₄₄₄]⁺), diethylmethylisobutyl-phosphonium ([P₁₂₂₄]⁺), trihexdecylphosphonium ([P₆₆₆₁₀]⁺), trihexyltetradecylphosphonium ([P₆₆₆₁₄]⁺), and combinations thereof.

The anion may include, for example only, hexafluoroarsenate, hexafluorophosphate, bis(fluorosulfonyl)imide (FSI), bis(trifluoromethanesulfonyl(imide) (TFSI), perchlorate, tetrafluoroborate, cyclo-difluoromethane-1,1-bis(sulfonyl)imide (DMSI), bis(perfluoroethanesulfonyl)imide (BETI), bis(oxalate)borate (BOB), difluoro(oxalato)borate (DFOB), bis(fluoromalonato)boarate (BFMB), and combinations thereof.

The optional diluent solvent may be added so as to decrease the viscosity and/or to improve the lithium ionic conductivity of the ionic liquid. The optional diluent solvent may be a solvent having a low-boiling point. For example, the solvent may have a boiling point less than or equal to about 150° C., and in certain aspects, optionally less than or equal to about 100° C. The optional diluent solvent may include, for example only, dimethyl carbonate, ethylene carbonate, ethyl acetate, acetonitrile, acetone, toluene, propylene carbonate, diethyl carbonate, 1,2,2-tetrafluoroethyl, 2,2,3,3-tetrafluoropropyl ether, and combinations thereof.

The solid component may include, for example only, one or more organic polymers, inorganic oxides, organic polymer/inorganic oxide (i.e., polymer/oxide) hybrids, metal-organic frameworks (MOFs), and others. The one or more organic polymers may include, for example only, poly(ethylene oxide)s (PEO)

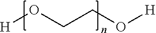

where 1000≤n≤10,000,000; one or more poly(vinylidene fluoride-co-hexafluoropropylene)s (PVDF=HFP)

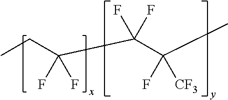

where 1,000≤x≤10,000,000 and 1,000≤y≤10,000,000; one or more poly(methyl methacrylate)s (PMMA)

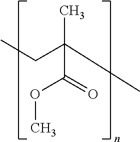

where 1,000≤n≤10,000,000; one or more carboxymethyl celluloses (CMC)

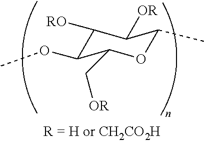

where 1,000≤n≤10,000,000; one or more polyacrylonitriles (PAN)

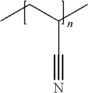

where 1,000≤n≤10,000,000; one or more polyvinylidene difluoride (PVDF)

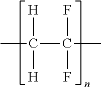

where 1,000≤n≤10,000,000; one or more poly(vinyl alcohol)s (PVA)

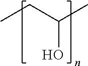

where 1,000≤n≤10,000,000; one or more polyvinylpyrrolidone (PVP)

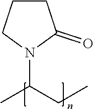

where 1,000≤n≤10,000,000; and combinations thereof. The one or more inorganic oxides may include, for example only, SiO₂, Al₂O₃, TiO₂, ZrO₂, and combinations thereof. The one or more metal-organic frameworks (MOFs) may include, for example only, MIL-101, UiO-67, ZIF-8, and combinations thereof.

In certain variations, the ionogel 100 may further include one or more lithium salts. For example, the ionogel 100 may include greater than or equal to 0% to less than or equal to about 40 wt. %, and in certain aspects, optionally greater than or equal to about 5 wt. % to less than or equal to about 20 wt. %, of the one or more lithium salts. The one or more lithium salts include a lithium cation and anion, such as hexafluoroarsenate, hexafluorophosphate, bis(fluorosulfonyl)imide (FSI), perchlorate, tetrafluoroborate, cyclo-difluoromethane-1,1-bis(sulfonyl)imide (DMSI), bis(trifluoromethanesulfonyl)imide (TFSI), bis(perfluoroethanesulfonyl)imide (BETI), bis(oxalate)borate (BOB), difluoro(oxalato)borate (DFOB), and/or bis(fluoromalonato)borate (BFMB), by way of non-limiting example.

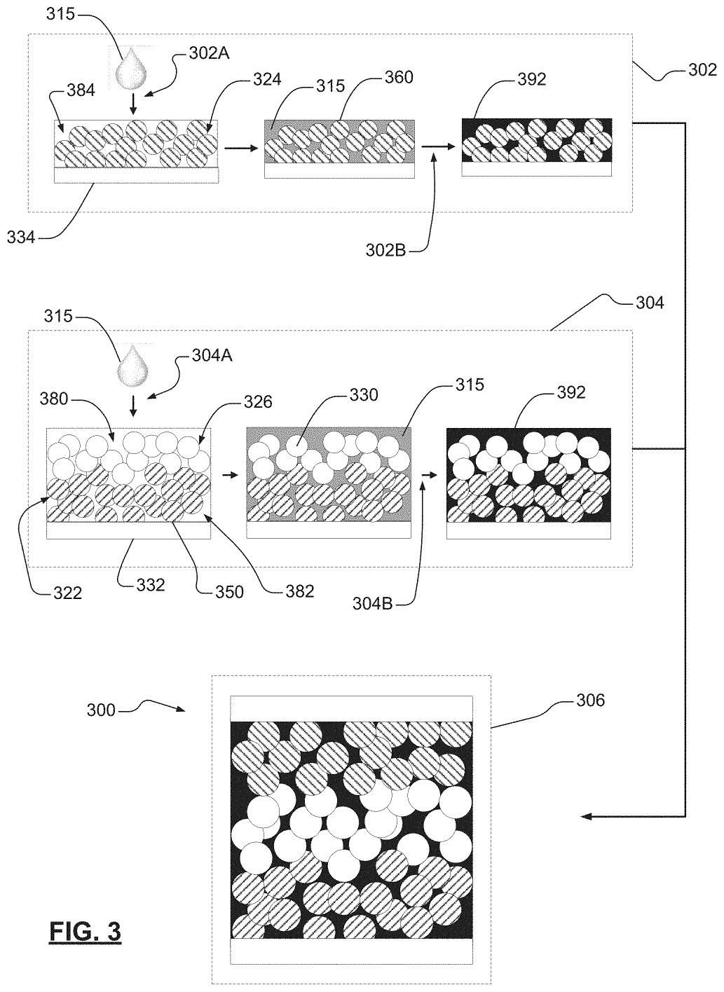

In various aspects, the present disclosure provides a method for preparing a solid-state battery having an ionogel, such as illustrated in FIG. 1B. As illustrated in FIG. 3, the method may generally include contacting a first electrode 324 with an ionogel precursor solution 315 (i.e., step 302); contacting a second electrode 322 with the ionogel precursor solution 315 (i.e., step 304); and assembling the first and second electrodes 324, 322 so as to form the solid-state battery 300 (i.e., step 306). Steps 302 and 304 may occur concurrently or consecutively.

The first electrode 324 may be a positive electrode, and like the positive electrode 24 detailed in the instance of FIGS. 1A and 1B, positive electrode 324 may be defined by a plurality of positive solid-state electroactive particles 360. In certain instances, though not illustrated in FIG. 3, the positive electrode 324 may also be a composite comprising a mixture of the positive solid-state electroactive particles 360 and a first plurality of solid-state electrolyte particles (not shown). The positive solid-state electroactive particles 360 (and/or the first plurality of solid-state electrolyte particles) may be disposed as a layer adjacent to a surface of a positive electrode current collector 334. Such positive electrodes 324 may have an interparticle porosity 384. Such positive electrodes 324 may have an interparticle porosity 384 between the positive solid-state electroactive particles 360 (and/or the first plurality of solid-state electrolyte particles), similar to FIG. 1A, that is greater than or equal to about 1 vol. % to less than or equal to about 20 vol. %, and optionally greater than or equal to 5 vol. % to less than or equal to about 10 vol. %.

The second electrode 322 may be a negative electrode, and like the negative electrode 22 detailed in the instance of FIGS. 1A and 1B, negative electrode 322 may be defined by a plurality of negative solid-state electroactive particles 350. In certain instances, though not illustrated in FIG. 3, the negative electrode 322 may also be a composite comprising a mixture of the negative solid-state electroactive particles 350 and a second plurality of solid-state electrolyte particles (not shown). The negative solid-state electroactive particles 350 (and/or the second plurality of solid-state electrolyte particles) may be disposed as a layer adjacent to a surface of a negative electrode current collector 332. Such negative electrodes 322 may have an interparticle porosity 382 between the negative solid-state electroactive particles 350 (and/or the second plurality of solid-state electrolyte particles), similar to FIG. 1A, that is greater than or equal to about 0 vol. % to less than or equal to about 20 vol. %.

As illustrated, a solid-state electrolyte layer 326 may be disposed adjacent to an exposed surface of the negative electrode 322. The solid-state electrolyte layer 326 may be defined by a third plurality of solid-state electrolyte particles 330. Such solid-state electrolyte layers 326 may have an interparticle porosity 380 between the third plurality of solid-state electrolyte particles 330, similar to FIG. 1A, that is greater than 0 vol. % to less than or equal to about 50 vol. %, greater than or equal to about 1 vol. % to less than or equal to about 40 vol. %, or greater than or equal to about 2 vol. % to less than or equal to about 20 vol. %. Further, similar to the instance of FIGS. 1A and 1B detailed above, the third plurality of solid-state electrolyte particles 330 may include solid-state electrolyte materials that are the same or different from the solid-state electrolyte materials defining the first plurality of solid-state electrolyte particles and/or the second plurality of solid-state electrolyte particles, respectively.

Moreover, though not presently illustrated, the skilled artisan will appreciate that in certain variations, such as illustrated in FIG. 2C, a first solid-state electrolyte layer may be disposed on the first electrode 324 and a second solid-state electrolyte layer may be disposed on the second electrode 322, and that the first and second solid-state electrolyte layers may together define a solid-state electrolyte layer of the solid-state battery. In such instances, the first and second solid-state electrolyte layers may be the same or different. Similarly, though not presently illustrated, the skilled artisan will appreciate that in certain variations, such as illustrated in FIG. 2B, the solid-state electrolyte layer may be disposed adjacent to an exposed surface of the positive electrode.

With renewed reference to FIG. 3, method step 302 includes (at 302A) contacting the first electrode 324 with an ionogel precursor solution 315. For example, the ionogel precursor solution 315 may be added in a drop-wise or spray fashion to the first electrode 324 so as to impregnate the first electrode 324 with the ionogel precursor solution 315. For example, the ionogel precursor solution 315 may substantially fill void spaces or pores between the positive solid-state electroactive particles 360 (and/or the first plurality of solid-state electrolyte particles). The ionogel precursor solution 315 includes the mixture of ionic liquid, solid component, and dilute solvent, as described above, in a liquid form. The method step 302 includes (at 302B) removing a dilute solvent from the ionogel precursor solution 315 so as to form an ionogel 392 within the first electrode 324, similar to FIG. 1B. By way of non-limiting example, in certain variations, the ionogel precursor solution 315 may include Li(G3)TFSI (95 wt. %) (4.75 g (G3:triglyme); PVDF-HFP (5 wt. %) (0.25 g); and THF (100 wt. %) (5.0 g). In such instances, THF may be removed so as to form an ionogel 392.

Method step 304 includes (at 304A) contacting the second electrode 322 with the ionogel precursor solution 315. For example, the ionogel precursor solution 315 may be added in a drop-wise or spray fashion to the second electrode 322 so as to impregnate the second electrode 322 with the ionogel precursor solution 315. For example, the ionogel precursor solution 315 may substantially fill void spaces or pores between the negative solid-state electroactive particles 350 (and/or the second plurality of solid-state electrolyte particles). The method step 304 includes (at 304B) removing a dilute solvent from the ionogel precursor solution 315 so as to form an ionogel 392 within the second electrode 322, similar to FIG. 1B.

Method step 306 includes contacting the first and second electrodes 324, 322 so as to define the battery 300, having a configuration similar to that discussed in the context of FIG. 1B.

Though the above illustrated examples (FIGS. 1A and 1B) include a single positive electrode (i.e., cathode) 24 and a single negative electrode (i.e., anode) 22, the skilled artisan will recognize that the above teachings apply to various other configurations, including those having one or more cathodes and one or more anodes, as well as various current collectors with electroactive particle layers disposed on or adjacent to one or more surfaces thereof. For example, as illustrated in FIGS. 4A-4C, a solid-state battery 400 may include a plurality of electrodes, such as a first bipolar electrode 402A and a second bipolar electrode 402B. The asterisks in FIGS. 4A-4C are meant to illustrate that the battery 400 may include one or more additional electrodes, as would be appreciated by the skilled artisan.

Each of the bipolar electrodes 402A, 402B includes a first plurality of electroactive material particles 450 disposed adjacent to or on a first side or surface 432 of a current collector 436 and a second plurality of electroactive material particles 460 disposed adjacent to or on a second side or surface 434 of the current collector 436. The first plurality of electroactive material particles 450 may be negative solid-state electroactive material particles, such as detailed above in the context of negative solid-state electroactive particles 50. The second plurality of electroactive material particles 460 may be positive solid-state electroactive material particles, such as detailed above in the context of positive solid-state electroactive particles 60.

In certain variations, as illustrated, a first plurality of solid-state electrolyte particles 490 may be mixed or intermingled with the first plurality of electroactive material particles 450; and a second plurality of solid-state electrolyte particles 492 may be mixed or intermingled with the second plurality of electroactive material particles 460. A solid-state electrolyte layer 426 may be disposed between consecutive electrodes 402A, 402B. The solid-state electrolyte layer 426 is a separating layer that physically separates the first electrode 402A and the second electrode 402B. The solid-state electrolyte layer 426 may be defined by a third plurality of solid-state electrolyte particles 430. As in the instance of FIGS. 1A and 1B, the first, second, and third pluralities of electroactive material particles 450, 460, 430 may be the same or different.

As in the instance of, for example FIG. 1B, detailed above, an ionogel 498 may be disposed within the battery 400 so as to wet interfaces and/or fill void spaces between the solid-state electrolyte particles 450, 460 and/or the solid-state electrolyte material particles 430, 490, 492 so as to, for example only, reduce interparticle porosity and improve ionic contact.

With renewed reference to 4A, the current collector 436 may have a thickness greater than or equal to about 2 μm to less than or equal to about 60 μm, and in certain aspects, optionally greater than or equal to about 5 μm to less than or equal to about 30 μm. The current collector 436 may include at least one of stainless steel, aluminum, nickel, iron, titanium, copper, tin, or any other electrically conductive material known to those of skill in the art. In certain variations, the current collector 436 may be a cladded foil (i.e., where one side (e.g., first side) of the current collector comprises one metal (e.g., first metal) and another side (e.g., second side) of the current collector comprises another metal (e.g., second metal)) including, for example only, aluminum-copper (Al—Cu), nickel-copper (Ni—Cu), stainless steel-copper (SS-Cu), aluminum-copper (Al—Ni), aluminum-stainless steel (Al-SS), and nickel-stainless steel(Ni-SS). In certain variations, the current collector 436 may be pre-coated, such as carbon-coated aluminum current collectors.

In other variations, as illustrated in FIG. 4B, the current collector 436 may include a first current collector 438 and a second current collector 442. As illustrated, the first current collector 438 may define the first side or surface 432 of the current collector 436 and the second current collector 442 may define the second side or surface 434 of the current collector 436. As such, the first current collector 438 may be adjacent to or near the first plurality of electroactive material particles 450 (and first plurality of solid-state electrolyte particles 490) and the second current collector 442 may be adjacent to or near the second plurality of electroactive material particles 460 (and second plurality of solid-state electrolyte particles 492).

The first current collector 438 may be different from the second current collector 442. In certain variations, the first current collector 438 may be a negative electrode current collector and the second current collector 442 may be a positive electrode current collector. In each instance, the first and second current collectors 438, 442 may each comprise at least one of stainless steel, aluminum, nickel, iron, titanium, copper, tin, or any other electrically conductive material known to those of skill in the art. The first and second current collectors 438, 442 may each have a thickness such that the current collector 436 has a thickness greater than or equal to about 2 μm to less than or equal to about 60 μm, and in certain aspects, optionally greater than or equal to about 5 μm to less than or equal to about 20 μm.

In certain variations, such as illustrated in FIG. 4C, the battery 400 may include one or more polymer blockers. A polymer blocker may be applied at or adjacent to a border of a cell unit so as to mitigate potential ionic short-circuiting. For example, polymer blockers may contact or connect one or more current collectors at or adjacent to the border of the cell unit. As illustrated, a first polymer blocker 470A may be disposed at or towards a first end 472 of the current collector 436 of a first electrode 402A and at or towards a first end 472 of the current collector 436 of a second electrode 402B such that the first polymer blocker 470A connects the first and second electrodes 402A, 402B. A second polymer blocker 470B may be disposed at or towards a second end 474 of the current collector 436 of a first electrode 402A and at or towards a second end 474 of the current collector 436 of a second electrode 402B such that the second polymer blocker 470B also connects the first and second electrodes 402A, 402B. Though a single polymer blocker pair is illustrated (i.e., polymer blockers 470A, 470B), the skilled artisan will appreciate that the present teachings may be applied also to batteries where polymer blockers are applied to each cell unit and/or alternating cell units and/or various other battery and cell configurations.

The polymer blockers 470A, 470B comprise an ionic and/or electronic insulating material having a strong adhesion force (for example, greater than or equal to about 0.01 MPa to less than or equal to about 1000 MPa, and in certain aspects, optionally greater than or equal to about 0.1 MPa to less than or equal to about 40 MPa) and excellent thermostability (for example, greater than or equal to about 40° C. to less than or equal to about 200° C., and in certain aspects, optionally greater than or equal to about 45° C. to less than or equal to about 150° C.). For example, each polymer blocker 470A, 470B may include at least one of a hot-melt adhesive (such as urethane resin, polyamide resin, polyolefin resin); a polyethylene resin; a polypropylene resin; a resin containing an amorphous polypropylene resin as a main component and obtained by copolymerizing, for example, ethylene, propylene, and butene; silicone; a polyimide resin; an epoxy resin; an acrylic resin; a rubber (such as ethylene-propylenediene rubber (EPDM)); an isocyanate adhesive; an acrylic resin adhesive; and a cyanoacrylate adhesive. Each polymer blocker 470A, 470B may have a thickness greater than or equal to about 2 μm to less than or equal to about 200 μm, and in certain aspects, optionally greater than or equal to about 40 μm to less than or equal to about 150 μm. The skilled artisan will appreciate that polymer blockers having various other configurations may also be used within the battery 400 so as to mitigate potential ionic short-circuiting.

Certain features of the current technology are further illustrated in the following non-limiting example.

### Example

An example cell 500 is prepared in accordance with various aspects of the present disclosure. For example, the example cell 500 may include solid-state electrodes and a solid-state electrolyte layer disposed therebetween. The solid-state electrolyte layer may include a first plurality of solid-state electrolyte particles, such as detailed above, for example in the context of FIG. 1B. For example, the first plurality of solid-state electrolyte particles may comprise LATP. A first solid-state electrode may be a negative electrode including a plurality of negative solid-state electroactive particles and a second plurality of solid-state electrolyte particles, such as detailed above, for example in the context of FIG. 1B. For example, the second plurality of solid-state electrolyte particles may comprise LLZO. A second solid-state electrode may be a positive electrode including a plurality of positive solid-state electroactive particles and a third plurality of solid-state electrolyte particles such as detailed above, for example in the context of FIG. 1B. For example, the third plurality of solid-state electrolyte particles may comprise LATP. The example cell 500 may include an ionogel comprising PVDF-HFP+Li(G3) TFSI ionic liquid.

A comparative cell 502 is prepared that having the same solid-state electrodes and a solid-state electrolyte layer as the example cell 500, but which in place of the ionogel includes a traditional gel, such as PVDF-HFP+LiPF₆-EC/PC/DMC.

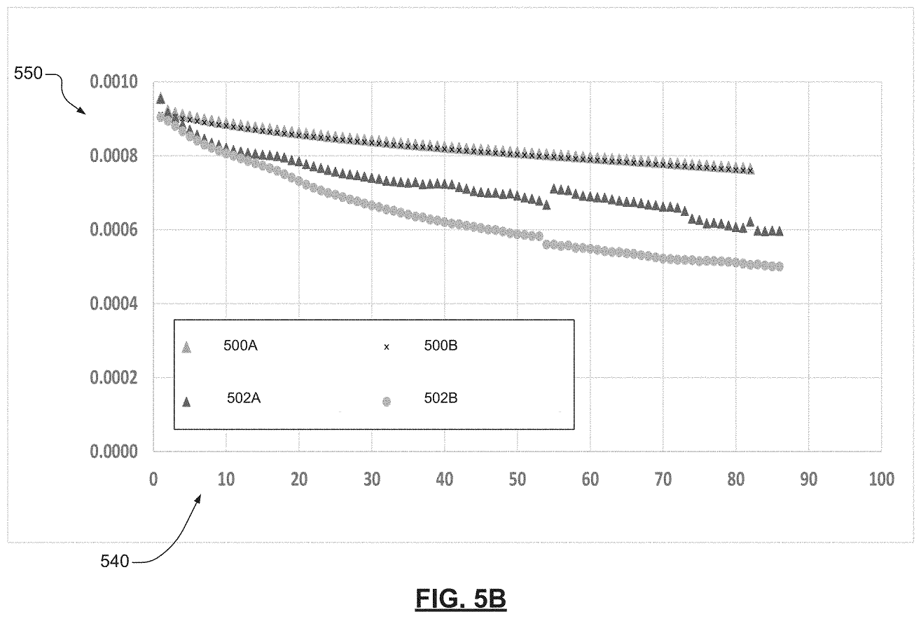

FIG. 5A illustrate 1C charge-discharge plots of each of the example cell 500 and the comparative cell 502 at 80° C. “1C” refers to cells that can be fully charged and discharged within 1 hour. The x-axis 510 represents time in seconds (s). The y-axis 520 represents voltage (V). As illustrated, example cell 500 including ionogel in accordance with various aspects of the current technology has improved discharge capacity of 0.874 mAh when compared to the comparative cell 502 including a traditional gel, which has a discharge capacity of 0.792 mAh.

FIG. 5B illustrates the comparative 1C cycling capability of the comparative cells 500, 502. Line 500A represents charging for example cell 500. Line 500B represents discharge for example cell 500. Line 502A represents charging for comparative cell 502. Line 502B represents discharging for comparative cell 502. The x-axis 540 represents cycle number. The y-axis 520 represents capacity (Ah). As illustrated, example cell 500 including ionogel in accordance with various aspects of the current technology has improved Coulombic efficiency (which is equal to [(discharge capacity/charge capacity)*100]) and long-term cycling stability when compared to the comparative cell 502 including a traditional gel.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A solid-state battery comprising:
two or more electrodes, each electrode comprising a plurality of solid-state electroactive particles;
one or more solid-state electrolyte layers, each solid-state electrolyte layer comprising a plurality of solid-state electrolyte particles, wherein a first solid-state electrolyte layer of the one or more solid-state electrolyte layers is disposed between a first electrode and a second electrode of the two or more electrodes; and
an ionogel disposed within void spaces between the two or more electrodes, the solid-state electroactive particles of the two or more electrodes, the solid-state electrolyte particles of the one or more solid-state electrolyte layers, and the one or more solid-state electrolyte layers, such that the solid-state battery has an interparticle porosity of less than or equal to about 20 vol. %, wherein the ionogel has an ionic conductivity greater than or equal to about 0.1 mS/Cm to less than or equal to about 10 mS/cm.

2. The solid-state battery of claim 1, wherein the ionogel comprises greater than or equal to about 30 wt. % to less than or equal to about 95 wt. % of an ionic liquid and greater than or equal to about 2 wt. % to less than or equal to about 40 wt. % of a solid component.

3. The solid-state battery of claim 2, wherein the solid component comprises at least one of an organic polymer, an inorganic oxide, a polymer/oxide hybrid, and a metal-organic framework (MOFs).

4. The solid-state battery of claim 3, wherein the organic polymer is selected from the group consisting of: poly(ethylene oxide)s (PEO) (where 1,000≤n≤10,000,000), poly(vinylidene fluoride-co-hexafluoropropylene)s (PVDF=HFP) (where 1,000≤x≤10,000,000 and 1,000≤y≤10,000,000), poly(methyl methacrylate)s (PMMA) (where 1,000≤n≤10,000,000), carboxymethyl celluloses (CMC) (where 1,000≤n≤10,000,000), polyacrylonitriles (PAN) (where 1,000≤n≤10,000,000), polyvinylidene difluoride (PVDF) (where 1,000≤n≤10,000,000), one or more poly(vinyl alcohol)s (PVA) (where 1,000≤n≤10,000,000), one or more polyvinylpyrrolidone (PVP) (where 1,000≤n≤10,000,000), and combinations thereof;
the inorganic oxide is selected from the group consisting of: SiO₂, Al₂O₃, TiO₂, ZrO₂, and combinations thereof;
the polymer/oxide hybrid comprises one or more of the organic polymers and one or more of the inorganic oxides; and
the one or more metal-organic frameworks (MOFs) is selected from the group consisting of: only, MIL-101, UiO-67, ZIF-8, and combinations thereof.

5. The solid-state battery of claim 2, wherein the ionic liquid comprises a cation and an anion,
wherein the cation is selected from the group consisting of: Li(triglyme)methylimidazolium ([Li(G3)]⁺), Li(tetraglyme) ([Li(G4)⁺], 1-ethyl-3 ([Emim]⁺), 1-propyl-3-methylimidazolium ([Pmim]⁺), 1-butyl-3-methylimidazolium ([Bmim]⁺), 1,2-dimethyl-3-butylimidazolium ([DMBim]), 1-Alkyl-3-methylimidazolium ([Cnmim]⁺), 1-allyl-3-methylimidazolium ([Amim]⁺), 1,3-diallylimidazolium ([Daim]⁺), 1-allyl-3-vinylimidazolium ([Avim]⁺); 1-vinyl-3-ethylimidazolium ([Veim]⁺), 1-cyanomethyl-3-methylimidazolium ([MCNim]⁺); 1,3-dicyanomethyl-imidazolium ([BCNim]⁺), 1-propyl-1-methylpiperidinium ([PP₁₃]⁺), 1-butyl-1-methylpiperidinium ([PP₁₄]⁺), 1-methyl-1-ethylpyrrolidinium ([Pyr₁₂]⁺), 1-propyl-1-methylpyrrolidinium ([Pyr₁₃]⁺), 1-butyl-1-methylpyrrolidinium ([Pyr₁₄]⁺), methyl-methylcarboxymethyl-pyrrolidinium([MMMPyr]⁺), tetramethylammonium ([N₁₁₁₁]⁺), tetraethylammonium ([N_{2222]}⁺), tributylmethylammonium ([N₄₄₄₁]⁺), tiallyldimethylammonium ([DADMA]⁺), N—N-diethyl-N-methyl-N-(2-methoxyethyl)ammonium ([DEME]⁺), N,N-Diethyl-N-(2-methacryloylethyl)-N-methylammonium ([DEMM]⁺), trimethylisobutyl-phosphonium ([P₁₁₁ᵢ₄]⁺), triisobutylmethylphosphonium ([P₁ᵢ₄₄₄]⁺), tributylmethylphosphonium ([P₁₄₄₄]⁺), diethylmethylisobutyl-phosphonium ([P₁₂₂₄]⁺), trihexdecylphosphonium ([P₆₆₆₁₀]⁺), trihexyltetradecylphosphonium ([P₆₆₆₁₄]⁺), and combinations thereof, and
wherein the anion is selected from the group consisting of: hexafluoroarsenate, hexafluorophosphate, bis(fluorosulfonyl)imide (FSI), bis(trifluoromethanesulfonyl(imide) (TFSI), perchlorate, tetrafluoroborate, cyclo-difluoromethane-1,1-bis(sulfonyl)imide (DMSI), bis(perfluoroethanesulfonyl)imide (BETI), bis(oxalate)borate (BOB), difluoro(oxalato)borate (DFOB), bis(fluoromalonato)boarate (BFMB), and combinations thereof.

6. The solid-state battery of claim 5, wherein the ionic liquid further comprises a low-boiling point solvent selected from the group consisting of: dimethyl carbonate, ethylene carbonate, ethyl acetate, acetonitrile, acetone, toluene, propylene carbonate, diethyl carbonate, 1,2,2-tetrafluoroethyl, 2,2,3,3-tetrafluoropropyl ether, and combinations thereof.

7. The solid-state battery of claim 2, wherein the ionogel further comprises greater than 0 wt. % to less than about 40 wt. % of one or more lithium salts, wherein each lithium salt comprises an anion selected from hexafluoroarsenate, hexafluorophosphate, bis(fluorosulfonyl)imide (FSI), perchlorate, tetrafluoroborate, cyclo-difluoromethane-1,1-bis(sulfonyl)imide (DMSI), bis(trifluoromethanesulfonyl)imide (TFSI), bis(perfluoroethanesulfonyl)imide (BETI), bis(oxalate)borate (BOB), difluoro(oxalato)borate (DFOB), and bis(fluoromalonato)borate (BFMB).

8. The solid-state battery of claim 1, wherein the solid-state electrolyte layer comprises:
a first layer comprising a first plurality of solid-state electrolyte particles, and
a second layer comprising a second plurality of solid-state electrolyte particles, wherein the first and second pluralities of solid-state electrolyte particles are the same or different and first and second pluralities of solid-state electrolyte particles define the plurality of solid-state electrolyte particles.

9. The solid-state battery of claim 1, further comprising two or more current collectors, wherein a first current collector of the two or more current collectors is disposed adjacent to the first electrode and a second current collector of the two or more current collectors is disposed adjacent to the second electrode.

10. The solid-state battery of claim 9, wherein at least one of the first and second current collector comprises:
a first half comprising a first material, and
a second half comprising a second material, wherein the second half is substantially parallel with the first half, and the first and second materials are different.

11. The solid-state battery of claim 9, further comprising a polymer blocker, wherein the polymer blocker contacts the first current collector to the second current collector, and wherein the polymer blocker has a thickness greater than or equal to about 2 μm to less than or equal to about 200 μm and comprises an insulating material selected from the group consisting of: urethane resin, polyamide resin, polyolefin resin, polyethylene resin, polypropylene resin, ethylene, propylene, butene, silicone, polyimide resin, epoxy resin, acrylic resin, ethylene-propylenediene rubber (EPDM), an isocyanate adhesive, an acrylic resin adhesive, a cyanoacrylate adhesive, and a combination thereof.

12. The solid-state battery of claim 1, wherein the solid-state battery is a bipolar battery;
wherein the two or more electrodes comprise a first electrode, a second electrode, and one or more bipolar electrodes, the plurality of solid-state electroactive particles comprises a first plurality of solid-state electroactive particles and a second plurality of solid-state electroactive particles, and the one or more solid-state electrolyte layers comprise a first solid-state electrolyte layer and a second solid-state electrolyte layer;
wherein each bipolar electrode comprises a current collector and the first plurality of solid-state electroactive particles are disposed on a first side of the current collector and the second plurality of solid-state electroactive particles are disposed on a second side of the current collector;
wherein the first solid-state electrolyte layer is disposed between the first electrode and a first side of the one or more bipolar electrodes and the second solid-state electrolyte is disposed between a second side of the one or more bipolar electrodes and the second electrode; and
wherein the ionogel is further disposed within void spaces between the first plurality of solid-state electroactive particles and the second plurality of solid-state electroactive particles, the first solid-state electrolyte layer and the first electrode, the one or more bipolar electrodes, the one or more bipolar electrodes and the first solid-state electrolyte layer, the one or more bipolar electrodes and the second solid-state electrolyte layer, and the second solid-state electrolyte layer and the second electrode.

13. A solid-state electrode comprising:
an electrode layer comprising a plurality of solid-state electroactive particles,
a solid-state electrolyte layer disposed adjacent to the electrode layer, wherein the solid-state electrolyte layer comprises a plurality of solid-state electrolyte particles; and
an ionogel disposed within void spaces between the solid-state electroactive particles, the solid-state electrolyte particles, the electrode layer and the solid-state electrolyte layer such that the solid-state electrode has an interparticle porosity of less than or equal to about 20 vol. %, wherein the ionogel has an ionic conductivity greater than or equal to about 0.1 mS/cm to less than or equal to about 10 mS/cm.

14. The solid-state electrode of claim 13, wherein the ionogel comprises greater than or equal to about 30 wt. % to less than or equal to about 95 wt. % of an ionic liquid and greater than or equal to about 2 wt. % to less than or equal to about 40 wt. % of a solid component, wherein the ionic liquid comprises a cation and an anion and the solid component comprises at least one of an organic polymer, an inorganic oxide, a polymer/oxide hybrid, and a metal-organic framework (MOFs).

15. The solid-state electrode of claim 14, wherein the ionic liquid further comprises a low-boiling point solvent selected from the group consisting of: dimethyl carbonate, ethylene carbonate, ethyl acetate, acetonitrile, acetone, toluene, propylene carbonate, diethyl carbonate, 1,2,2-tetrafluoroethyl, 2,2,3,3-tetrafluoropropyl ether, and combinations thereof.

16. The solid-state electrode of claim 13, wherein the ionogel further comprises greater than 0 wt. % to less than about 40 wt. % of one or more lithium salts, wherein each lithium salt comprises an anion selected from hexafluoroarsenate, hexafluorophosphate, bis(fluorosulfonyl)imide (FSI), perchlorate, tetrafluoroborate, cyclo-difluoromethane-1,1-bis(sulfonyl)imide (DMSI), bis(trifluoromethanesulfonyl)imide (TFSI), bis(perfluoroethanesulfonyl)imide (BETI), bis(oxalate)borate (BOB), difluoro(oxalato)borate (DFOB), and bis(fluoromalonato)borate (BFMB).

17. A solid-state bipolar electrode comprising:
a first electrode layer disposed on a first side of a current collector, wherein the first electrode layer comprises a plurality of first solid-state electroactive particles;
a second electrode layer disposed on a second side of the current collector, wherein the second electrode layer comprises a plurality of second solid-state electroactive particles;
one or more solid-state electrolyte layers disposed adjacent to at least one of the plurality of first solid-state electroactive particles and the plurality of second solid-state electroactive particles, wherein each of the one or more solid-state electrolyte layers comprises a plurality of solid-state electrolyte particles; and
an ionogel disposed within void spaces between the first solid-state electroactive particles, the second solid-state electroactive particles, the solid-state electrolyte particles, the first electrode layer and the current collector, the second electrode layer and the current collector, the first electrode layer and the one or more solid-state electrolyte layers, and the second electrode layer and the one or more solid-state electrolyte layers such that the solid-state electrode has an interparticle porosity of less than or equal to about 20 vol. %, wherein the ionogel has an ionic conductivity greater than or equal to about 0.1 mS/cm to less than or equal to about 10 mS/cm.

18. The solid-state bipolar electrode of claim 17, wherein the current collector comprises:
a first half comprising a first material, and
a second half comprising a second material, wherein the second half is substantially parallel with the first half, and the first and second materials different.

19. The solid-state bipolar electrode of claim 17, wherein the ionogel comprises greater than or equal to about 30 wt. % to less than or equal to about 95 wt. % of an ionic liquid and greater than or equal to about 2 wt. % to less than or equal to about 40 wt. % of a solid component, wherein the ionic liquid comprises a cation and an anion and the solid component comprises at least one of an organic polymer, an inorganic oxide, a polymer/oxide hybrid, and a metal-organic framework (MOFs).

20. The solid-state bipolar electrode of claim 17, wherein the ionic liquid further comprises at least one of:
a low-boiling point solvent selected from the group consisting of: dimethyl carbonate, ethylene carbonate, ethyl acetate, acetonitrile, acetone, toluene, propylene carbonate, diethyl carbonate, 1,2,2-tetrafluoroethyl, 2,2,3,3-tetrafluoropropyl ether, and combinations thereof; and
a lithium salt comprising an anion selected from hexafluoroarsenate, hexafluorophosphate, bis(fluorosulfonyl)imide (FSI), perchlorate, tetrafluoroborate, cyclo-difluoromethane-1,1-bis(sulfonyl)imide (DMSI), bis(trifluoromethanesulfonyl)imide (TFSI), bis(perfluoroethanesulfonyl)imide (BETI), bis(oxalate)borate (BOB), difluoro(oxalato)borate (DFOB), and bis(fluoromalonato)borate (BFMB).
